(19) United States
(12) Patent Application Publication
(10) Pub. No.: US 2012/0299881 A1
(43) Pub. Date: Nov. 29, 2012

(54) SYSTEM FOR TRACKING AND PROCESSING HANDWRITTEN PEN STROKES ON MOBILE TERMINAL

(75) Inventors: Pierre DE MUELENAERE, Court-Saint-Etienne (BE); Olivier DUPONT, Sombreffe (BE); Patrick VERLEYSEN, Wavre (BE); Michel DAUW, Machelen (BE)

(73) Assignee: I.R.I.S., Mont-Saint-Guibert (BE)

(21) Appl. No.: 13/462,122

(22) Filed: May 2, 2012

Related U.S. Application Data
(60) Provisional application No. 61/490,671, filed on May 27, 2011.

(30) Foreign Application Priority Data
Oct. 31, 2011 (BE) 2011/0638

(51) Int. Cl. G06F 3/033

(52) U.S. Cl. 345/179

(57) ABSTRACT

A system for tracking and processing handwritten pen strokes, including: a digital pen to allow a user to write pen strokes on a substrate; a receiver station for use in combination with said digital pen and adapted for tracking said pen strokes and storing digital pen strokes which include electronic data representing said tracked pen strokes, said receiver station including a wireless transceiver adapted for communicating with a mobile terminal over a wireless connection to transfer said digital pen strokes to said mobile terminal; and a software application executable on said mobile terminal and including software code fragments for receiving and processing said transferred digital pen strokes.

### TECHNICAL FIELD

The present invention relates to a system for tracking and processing handwritten pen strokes on a mobile terminal.

### BACKGROUND ART

Digital writing instruments (or styluses), interchangeably referred to herein as “digital pens” regardless of whether or not they write in ink, can be used to capture pen strokes and to digitize them. Digital writing systems including character recognition software can be used to convert recorded pen strokes to image or text data.

Typically, digital pens operate with and send data to a host terminal (such as a personal computer) through a wired connection, as a supplement to keyboard or mouse input. This may be directly or indirectly via one or more receiving stations which receive a signal from the digital pen. The location of the digital pen is tracked with a terminal tracking mechanism, and location data may be written into memory of the host terminal.

On mobile terminals having touch screen such as Smartphone's, PDA's and tablet PC's, it is possible to capture handwriting notes and sketches by touching the screen with a finger or with a stylus. The capture of handwriting directly on the touch screen presents several limitations: ergonomic issues, very low precision, screen much smaller than typical paper notepad, etc.

Many mobile terminals do not offer the possibility to receive pen strokes from a digital pen as they have no proper port for the wired connection. In the case of USB data transfer, even if the mobile computer and the digital pen have an USB port, neither can be configured as a host. In any case, the use of a wired connection between a mobile terminal and an external device is usually seen as a major limitation to the ease of use of it.

### DISCLOSURE OF THE INVENTION

It is an aim of this invention to provide a system which does not show at least one of the above mentioned drawbacks.

According to the present invention, the aforementioned aim is achieved with a system for tracking and processing handwritten pen strokes, comprising; a digital pen to allow a user to write pen strokes on a substrate; a receiver station for use in combination with said digital pen and adapted for tracking said pen strokes and storing digital pen strokes which comprise electronic data representing said tracked pen strokes, said receiver station comprising a wireless transceiver adapted for communicating with a mobile terminal over a wireless connection to transfer said digital pen strokes to said mobile terminal; and a software application executable on said mobile terminal and comprising software code fragments for receiving and processing said transferred digital pen strokes.

In embodiments according to the present invention, the processing may comprise one or more of the following: image processing, character recognition, image compression, and file format conversion to a text format or any format combining image and text, including the processed data in an e-mail, storing for further processing or other. The further processing may comprise all of the above and can be performed on the mobile terminal (embedded processing) or externally, by using for example a SaaS (Software as a Service) delivery model.

In embodiments according to the present invention, the wireless connection between the receiver station and the mobile terminal can be a Bluetooth® connection, a Wifi connection or any other wireless connection. Preferably an RF wireless connection with a guaranteed bandwidth (or data throughput) is used, for smooth transfer of the pen strokes.

In embodiments according to the present invention, the digital pen strokes can contain position information and a time-stamp, so that the order of the pen strokes can be reconstructed.

### BRIEF DESCRIPTION OF THE DRAWINGS

The invention will be further elucidated by means of the following description and the appended drawings.

FIG. 1 shows a system for tracking and processing handwritten pen strokes according to the invention.

FIG. 2 shows an example of the combination of a color or grayscale image with the digitized pen strokes into a combined image.

FIG. 3 shows an example of the combination of a color or grayscale image with the text corresponding to the converted pen strokes into a combined image.

FIG. 4 shows an example of the combination of a color or grayscale image with the pen strokes and with the text corresponding to the converted pen strokes into a combined image.

FIG. 5 shows an embodiment of a receiver station for use in combination with a digital pen, and a way for attaching it to a substrate.

FIG. 6 shows an example of the receiver station of FIG. 5 attached to the top of a page.

FIG. 7 shows an example of the receiver station of FIG. 5 attached to the top right corner of a page.

FIG. 8 shows several embodiments of the processing of pen-strokes according to the present invention, as can be implemented on the system of FIG. 1.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the disclosure may be implemented rather than as limiting the scope of the invention.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

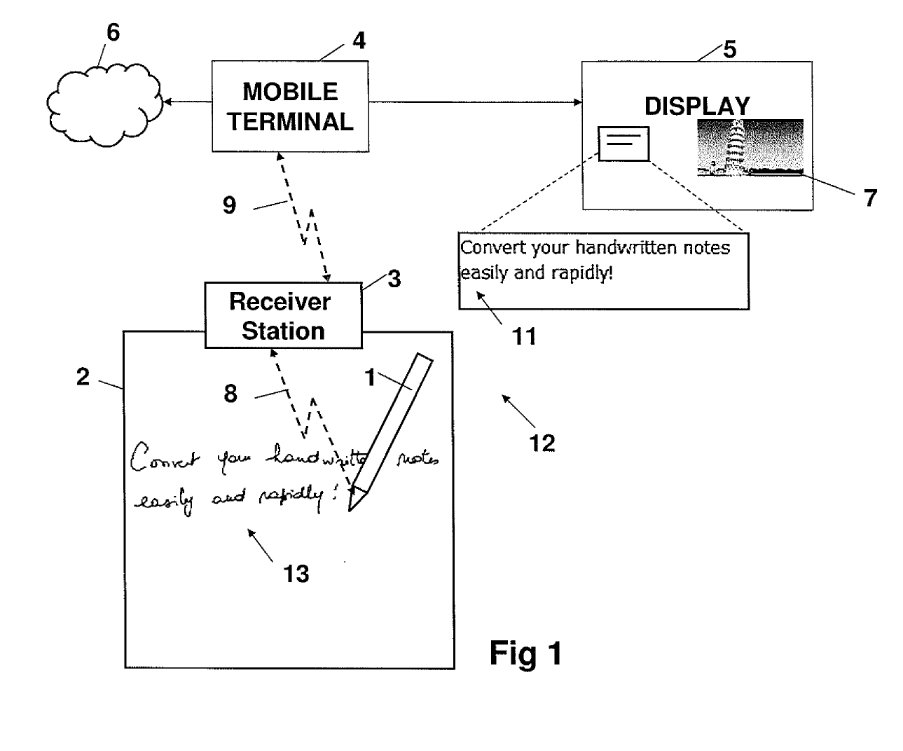

FIG. 1 shows a system 12 for tracking and processing handwritten pen strokes 13 on a mobile terminal 4, such as e.g. a laptop, a netbook®, an ipad®, a tablet PC, a PDA, or other suitable mobile devices. The pen strokes can be written by a hand-held writing instrument 1, such as e.g. a stylus, further referred to herein as “digital pen” 1. The digital pen 1 may write in ink on a substrate 2, preferably a markable writing surface such as e.g. paper, for creating also an ink copy (also called “hard copy”) of the writing or drawing that the user has made. The paper may e.g. be plain white paper with or without pre-printed lines or square of rectangular grids. Other kinds of substrates may also be used, e.g. colored paper, printed paper, published paper, a form printed to be filled out, but also e.g. a newspaper.

The mobile terminal 4 is wirelessly connected with the receiver station 3 which is used in combination with the digital pen 1, and has software code fragments for capturing and recording the pen strokes that are written by the user on the substrate 2, and can display the resulting graphical image 10 on a display 5. The display is preferably integrated in the mobile terminal 4, e.g. the LCD screen of an ipad, but may also be an external device. The screen 5 may be a touch-screen or not. The resolution of the screen 5 is not related to the resolution (or accuracy) of the captured pen strokes. This means that the handwritten pen-strokes may be captured in much more detail and with a much higher accuracy than what is possible by using the touch-screen as an input device.

In an embodiment of the system 12, the mobile terminal 4 is provided with an application software for compressing the reconstructed graphical image 10 for archiving (e.g. on a hard disk or a flash card or other memory or an external network drive, etc) or for sharing the image 10, e.g. by sending it over a network 6, e.g. via e-mail.

In an embodiment of the system 12, the application software uses (optical) character recognition techniques in order to get the digital text data 11 corresponding with the handwritten notes 13. The digital text data 11 may e.g. be represented as ASCII-character codes (without any formatting information such as color, font-type, font-size, etc), which may be saved as a “text-only” file. Alternatively the digital text data 11 may also comprise formatting data, such as e.g. color or font-size or font-type, and may e.g. be saved as a rich-text format (e.g. an “RFT-file”), or as a Microsoft® Msword® document, or as other document formats, e.g. WordPerfect®, MsWorks®, or other. But the digital text data 11 may also be represented as unicode characters, which allows also handwriting 13 of language such as Chinese or Japanese to be further processed.

The character recognition software which is used may convert the graphical data (such as e.g. a bitmap 10 with a graphical representation of the handwritten notes 13) into text data 11 along with position information and not keep the accompanied drawings (graphical data 10). The latter may however contain important information that the writer has sketched. Since character recognition software can make conversion mistakes (e.g. a character mismatch), the digital image 10 of the handwriting notes 13 may be needed in order to keep a correct reference. So, it is preferred to use character recognition software which keeps both the converted text 11 and the (graphical) image 10 of the handwriting note together, for archiving or for sending by e-mail 18.

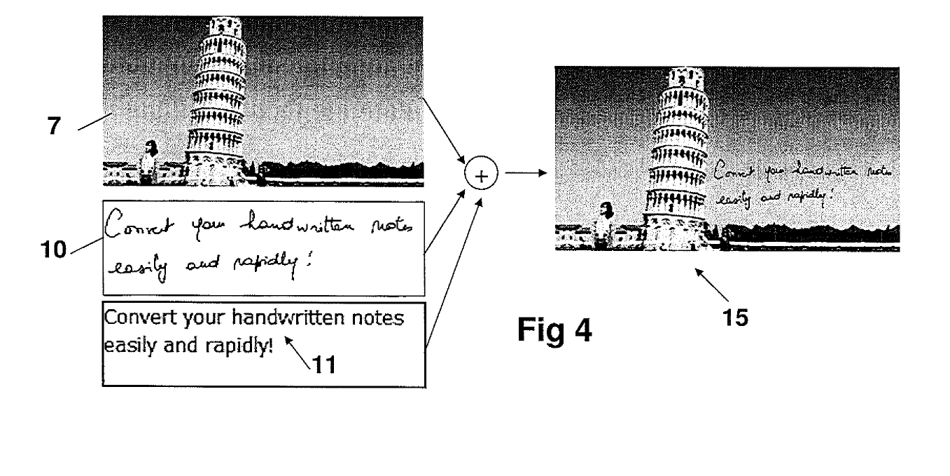

In an embodiment of the system, illustrated in FIG. 4, the image 10 of the pen strokes 13 is combined with the text 11 resulting from the character recognition software application, in a combined image 15 that keeps the graphical image 10, the text 11 and the coordinates of the text elements. The combination may be simple overlay (text or pen strokes over the image), or a semi-transparent overlay or by other combination techniques, such as e.g. color inversion. For example, the PDF and XPS formats have provisions to include image, text and text element coordinates and corresponding viewer software applications (e.g. Acrobat® reader from Adobe®) can be used to display the image 15 and to search the text 11. When the text-string to be searched is found, the corresponding graphical image portion is retrieved and displayed on screen (e.g. by automatic scrolling into the document), whereby the image portion corresponding to the searched text-string may be displayed in a different manner, e.g. by highlighting it. This method needs a character recognition software application that output the coordinates of the text elements (characters or words) in addition to the recognized text.

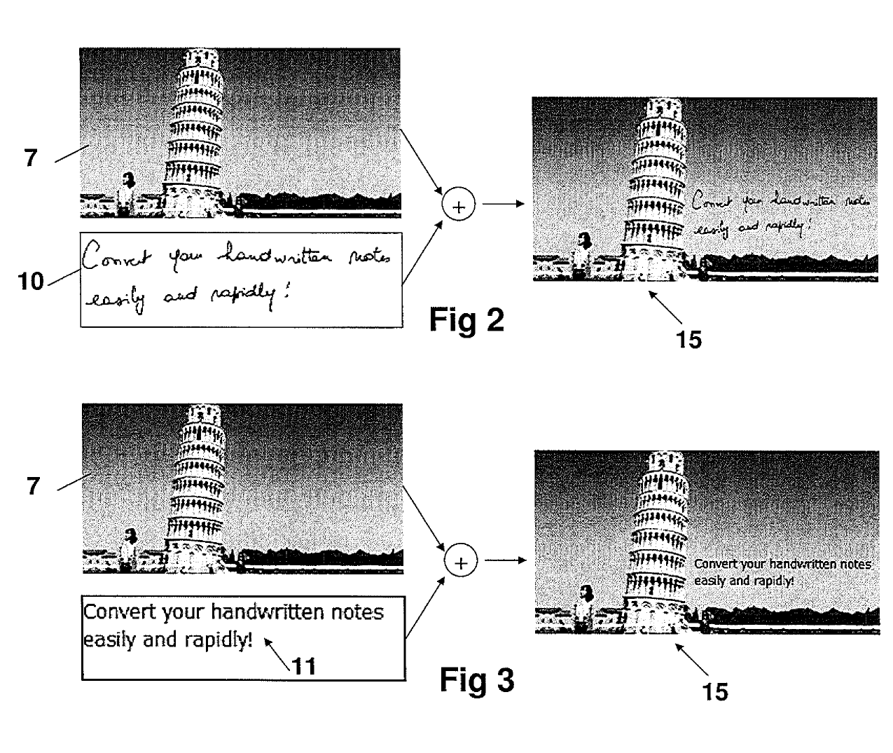

In an embodiment of the system, the image 10 of the handwritten notes 13 is combined with other images 7 such as e.g. the background image of a form to be filled out, or a picture (e.g. a photograph) or a screen-shot, or a scanned image, or any other images. An example is shown in FIG. 2. As an example, the digital pen 1 may be used to fill out a paper form, whereby the background image 7 of the form and the image 10 of the handwritings 13 are combined and stored together as a single file, in order to keep the correspondence between the two images. The background image 7 of the form may be derived from a pre-stored file in the mobile terminal 4, which may be recalled and printed each time it has to be filled. Optionally a digital photo of the person that fills the form may also be added in the images combination. This photo may e.g. be pre-stored, or may e.g. be taken by a camera of the mobile terminal 4, for example a still-picture camera or a video-camera such as e.g. a web-cam. The image 15 resulting from the combination of the bi-tonal image 10 of the pen strokes with the other one or more images 7 is a color or grayscale image (e.g. the background of the form) with added text (e.g. handwritten text as shown in FIG. 2, or reconstructed converted text as shown in FIG. 3). It is known that color or grayscale pictures, e.g. digital photos may be compressed using a compression algorithm such as e.g. JPEG or JPEG2000, which may provide a relatively high compression ratio (e.g. 5 times, or 10 times, or more) while keeping reasonable quality for most natural images. This is not the case however for handwritten notes 13. In order to keep a good legibility of the handwriting notes 13 and the text 10 of the form (or other details in the color or grayscale image), the image cannot be compressed with a high compression ratio, because the above mentioned methods (jpeg, jpeg2000, etc) are mainly adapted for compressing continuous-tone images such as digital photos, and typically yield highly visible artefacts when used on images with high detail, such as characters. This may be a problem as mobile terminals 4 generally have limited memory storage. For example, an ipad1® or ipad2® typically only has 16, 32 or 64 GBytes of storage capacity, which space cannot only be used for storing data, but is also used for storing the operating system, drivers and application software. Large files (e.g. larger than 6 Megabytes) may also cause problems for sending by e-mail, not only because most e-mailing systems only allow a limited size of attached files (e.g. 10 Megabyte), but also because of the time required to transmit them.

Therefore in an embodiment of the system of the present invention, the system software code also comprises code fragments for compressing the image 15 resulting from the combination of the graphical image 10 of the reconstructed pen strokes and the other images 7, by using a high compression method that segments the image 15 into bi-tonal (pen strokes, text, graphics) data and color (text and graphic colors, background color, pictures) data and compress those data separately with a compression method adapted to the data type. The high compression method could follow the MRC (Mixed Raster Content) model, object of the ITU-T recommendation T.44.

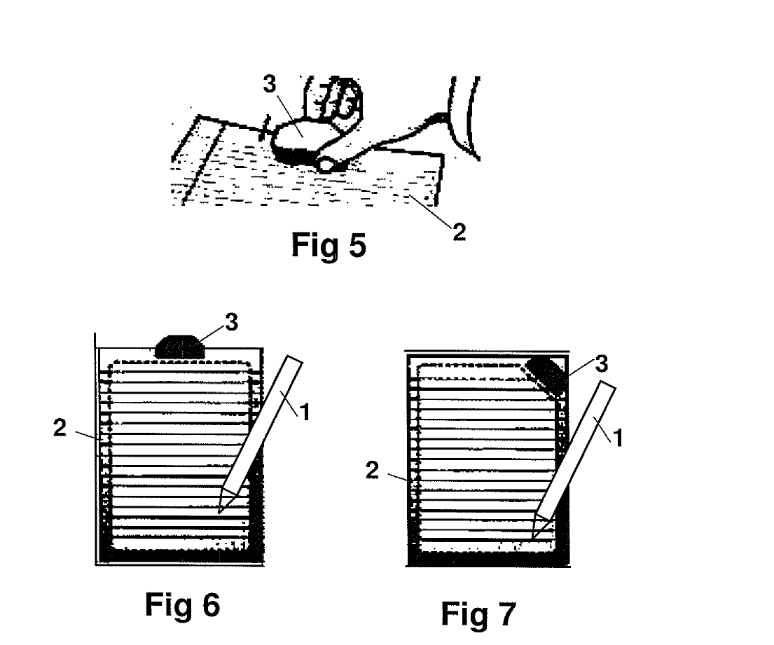

FIGS. 5-7 show examples of a digital pen 1 and a corresponding receiver station 3 for tracking and recording the pen tip movements, Embodiments of the receiver station 3 used in the system 12 according to the present invention may be a clip-on recording device 3 adapted to be clipped onto the substrate 2. FIG. 6 shows an example where the receiver station 3 is clipped at the top of a paper 2. FIG. 7 shows an example where the receiver station 3 is clipped at the top right corner of a paper 2, but other locations for positioning the receiver station 3 may also be used. The digital pen 1 and receiver station 3 may operate according to an ultrasound pen tracking mechanism as described in U.S. Pat. No. 7,839,394, “Electronic pen device” of Pegasus Technologies Ltd which is incorporated herein by reference in its entirety. Alternatively, the pen tracking mechanism can also be any other mechanism known to the person skilled in the art, such as e.g. Infra-red, laser tracking, or electronic tracking. Instead of a loose pen 1, also a touch tablet with a corresponding pen may be used in the system of the present invention.

The receiver station 3 may be a battery-powered device with internal memory, (e.g. volatile memory such as DRAM, or non-volatile memory such as flash-memory), capable of working in stand-alone mode (i.e. without being connected to the mobile terminal 4) for temporarily storing tracked pen strokes 13. The pen strokes are recorded in the memory of the receiver station 3. The pen-strokes can later be uploaded to the mobile terminal 4, saved or emailed as ordinary files. This system 12 allows handwritten email composition. According to the invention the pen strokes are imported in the mobile terminal 4 using the wireless link 9. Thereto the software code fragments of the mobile terminal 4 incorporate the protocol stack of the wireless link technology being used.

One particularly interesting short-range wireless communications protocol is widely known as Bluetooth®. Bluetooth technology, also known as IEEE 802.15.1 operates in the unlicensed industrial, scientific and medical (ISM) band at 2.4 GHz, and uses a spread spectrum technique to minimize interference. The core specification (core specification v2.0+EDR, published 4 Nov. 2004) for Bluetooth is available at http://bluetooth.com. The content of this core specification is hereby incorporated by reference in its entirety. Another interesting wireless communications protocol is Wifi, also known as IEEE 802.11 a/b/g/n. Preferably the mobile terminal 4 has an embedded RF transceiver.

The receiver station and mobile terminal can communicate by using the Bluetooth protocol implemented at either side by the protocol stack that manages the timing critical radio interface and deals with the high level data.

The receiver station can comprise a radio which is arranged for communicating with the mobile terminal, suitably via the Bluetooth wireless protocol. The radio is connected to a microprocessor arranged for controlling the transmission of signals between the receiver station and the mobile terminal.

The receiver station can comprise a silicon device containing the bluetooth radio and a microprocessor that implements the protocol stack.

Mobile terminals that support Bluetooth comprise a radio device and a protocol stack. Their protocol stack is implemented as part of their operating system and offers an API (Application Programming Interface) to the application software. The application software uses the API to verify or request that Bluetooth is enabled by the user, setup Bluetooth, find the digital pen device, connect to the digital pen device and manage the connection.

When uploading the recorded pen stroke data, the wireless link 9 is preferably configured in such as way that the data is transferred at the highest speed in the shortest possible time, while ensuring a reliable transmission.

Preferably the receiver station 3 can also be configured in a connected mode, or in some embodiments may only have the connected mode, (i.e. connected to the mobile terminal 4). In this mode the pen strokes are continuously tracked and transferred as soon as possible to the mobile terminal 4 via the wireless link 9. In this mode, the wireless link 9 is preferably configured in such a way that the delay between the pen and the mobile terminal 4 is minimized. Alternatively the wireless link 9 may also be configured in a low-power mode, for saving battery lifetime of the mobile terminal and/or the battery lifetime of the receiver station 3.

In an embodiment, the pen 1 may e.g. be configured as a writing device, whereby a force or pressure sensor built inside the pen tip is used for detecting when the pen tip is actually being used for writing, (which pen strokes 13 are then recorded). Optionally the pen 1 may also be configured for use as a pointing device like a mouse, whereby all pen movements are transferred to the mobile terminal 4 in real time. Optionally the pen 1 may also have a push button to simulate a mouse click.

In an embodiment the receiver station 3 stores a sequence of digitized positions of handwritten pen strokes 13 in the memory, and groups them as “virtual pages” corresponding to physical papers being written upon. Preferably the receiver station 3 has means for changing the “virtual page”, e.g. using a push-button, such that when the button is pushed, a new virtual page is started. The receiver station 3 may comprise sufficient memory to store e.g. 50 or 100 or more virtual pages, which may be ideal for students for taking notes in a classroom, while having the ability to edit them later.

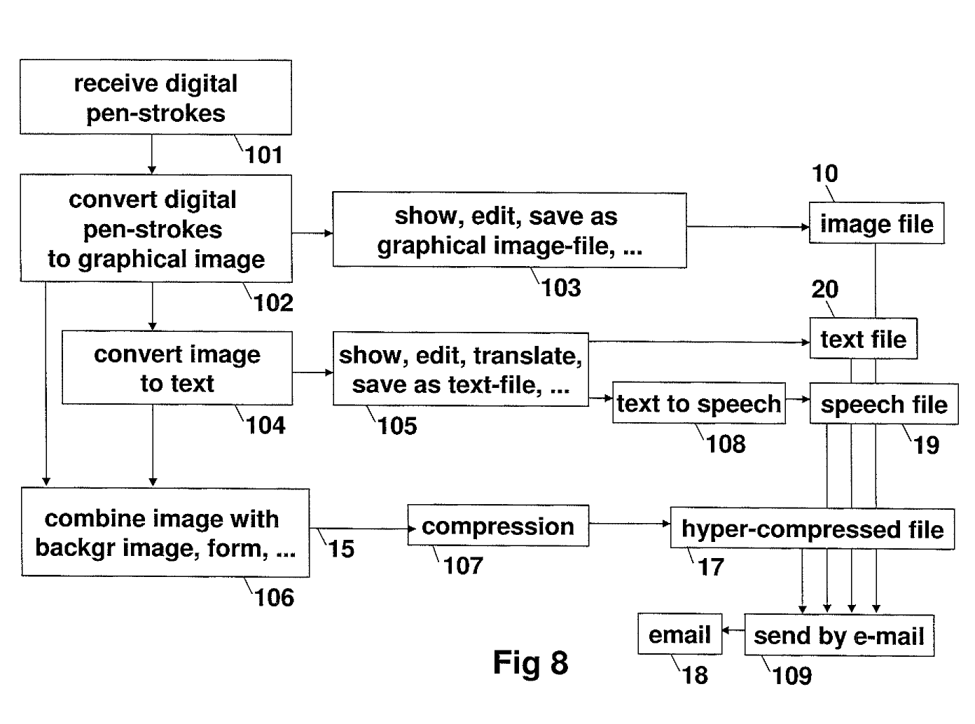

FIG. 8 illustrates some examples of software code fragments stored on the mobile terminal 4 of the system 12 according to the present invention. In software code fragment 101 the mobile terminal 4 receives digital pen-strokes 13 as digital data. In software code fragment 102 this digital data is converted to a graphical image 10. In optional software code fragment 103 this image file 10 (e.g. a bi-tone bitmap) may be displayed on the screen 5 of the mobile terminal 4, it may be edited, copied, etc, and/or saved as a graphical image file 10. The system 12 preferably also comprises software code fragments 104 for converting the graphical image 10 comprising the digital representation of the pen-strokes 13 into a text, e.g. ASCII text or unicode-text as described above, by performing character recognition. Optionally the system also comprises software code fragments 105 for editing, spelling checking, and/or saving the resulting text file, for example in pure text (TXT file format) or as rich text (RTF-file format) or other desired formats. Note that these text files are searchable, i.e. that a given character-string can easily and reliably be found in such a text-file. Optionally the software code fragments 105 also comprises fragments for translating the digital text 11 into another language (as an example, the user may write notes on a page 2 in Dutch language, and the digital text 11 may be machine-translated into English). As a non-limiting example, the software module 105 may use “google translate”, (at the time of writing freely available at URL: “http://www.google.be/language_tools?hl=nl”). Optionally the system of the present invention also comprises software code fragments 108 for converting the digital text 11 (or the translated digital text) into synthetic speech, using a text-to-speech converter. Such converters may use modules commercially available from several software suppliers (e.g. Nuance Communications®). The resulting speech may be stored in a speech file 19, e.g. in WAV-format or MP3-format, or any other suitable format. The system preferably also comprises software code fragments 106 for combining the pen stroke information, and/or the corresponding digital text information with other grayscale or color background images 7, as described above. The combined file 15 is preferably compressed in such a way that the digitized pen strokes 13 are kept at their highest recorded resolution, while the rest of the image (mainly belonging to the background image 7) may be compressed at a higher ratio. For this purpose the system of the present invention preferably comprises software code fragments 107 for compressing such a combined file. Preferably a hyper-compression algorithm is used. Examples of such high compression method are e.g. disclosed in the US patent applications U.S. Pat. No. 5,778,092(A) and US 2008273807 (A1) which are both hereby incorporated by reference herein in their entirety. Both algorithms use a low resolution foreground and a low resolution background plane, and a high resolution binary plane in order to achieve the required compression as well as high resolution for the text 11 or digitized pen strokes. Preferably the system 12 of the present invention also comprises software code fragments 109 for sending any combination of the image file 10, text file 20, speech file 19 or the compressed combined file 17 via e-mail.

The mobile terminal 4 may operate on a standard Microsoft® Windows® operation system, such as Microsoft® Windows XP®, or Windows 7®, but other operating systems may also be used, such as e.g. iOS, Android, Blackberry OS, Windows Phone 7, HP's webOS, or other.

The above mentioned software application code fragments may be stand-alone programs, or may be incorporated or embedded in driver software, or may be provided as plug-ins for cooperating with existing software applications such as e.g. Powerpoint® which is part of Office2007® from Microsoft®, or :Evernote® from Evernote Corporation but may also be provided in other ways known to the person skilled in the art.

1. A system for tracking and processing handwritten pen strokes, the system comprising:
a digital pen to allow a user to write pen strokes on a substrate;
a receiver station for use in combination with said digital pen and adapted for tracking said pen strokes and transferring digital pen strokes which comprise electronic data representing said tracked pen strokes, said receiver station comprising a wireless transceiver adapted for communicating with a mobile terminal over a wireless connection to transfer said digital pen strokes to said mobile terminal;
a software application executable on said mobile terminal and comprising software code fragments for receiving said transferred digital pen strokes over said wireless connection and for processing said transferred digital pen strokes.

2. The system according to claim 1, wherein said digital pen strokes comprise position information and a time-stamp.

3. The system according to claim 2, wherein said software application is adapted for reconstructing the order the pen strokes from the position information and the time-stamp.

4. The system according to claim 1, wherein the wireless connection between the receiver station and the mobile terminal is an RF wireless connection with a guaranteed bandwidth.

5. The system according to claim 1, wherein the wireless connection between the receiver station and the mobile terminal is an RF wireless connection with a guaranteed data throughput.

6. The system according to claim 1, wherein the wireless connection between the receiver station and the mobile terminal is an RF wireless connection with a guaranteed bandwidth and data throughput.

7. The system according to claim 1, wherein the wireless connection between the receiver station and the mobile terminal is one of the following: a Bluetooth® connection, a Wifi connection.

8. The system according to claim 1, wherein said software application comprises software code fragments for detecting among said digital pen strokes those which represent handwritten characters.

9. The system according to claim 8, wherein said software application comprises software code fragments for performing handwriting recognition to convert the digital pen strokes which represent handwritten characters into digital characters.

10. The system according to claim 9, wherein said software application comprises software code fragments for integrating said digital characters generated from said digital pen strokes into an e-mail,

11. The system according to claim 1, wherein said software application comprises software code fragments for transforming said digital pen strokes into graphical images which are displayable on a display of said mobile terminal and which graphically represent the written pen strokes of the user.

12. The system according to claim 11, wherein said software application comprises software code fragments for integrating said graphical images generated from said digital pen strokes into an e-mail.

13. The system according to claim 1, wherein said software application comprises software code fragments for converting a graphical image containing a combination of a plurality of said digital pen strokes and other colour images into a hyper-compressed document, wherein different elements of the graphical image are compressed with different compression algorithms optimized for the respective elements.

14. The system according to claim 13, wherein said software code fragments for said conversion are further provided for generating an electronically searchable file containing the hyper-compressed document and text recognized from said plurality of digital pen strokes.

15. The system according to claim 1, wherein said software application comprises software code fragments for temporarily storing the digital pen strokes or electronic data generated therefrom in a memory of said mobile terminal, for further processing at a later stage.

16. The system according to claim 15, wherein the system further comprises an external processing device adapted for communicating with said software application on said mobile terminal and for performing said further processing on said temporarily stored digital pen strokes or electronic data generated therefrom.

17. The system according to claim 1, wherein said software application is in a format executable on one of the following mobile terminals: a laptop computer, a netbook computer.

18. The system according to claim 1, wherein said software application is in a format executable on one of the following mobile terminals: a smartphone, a PDA, a tablet PC.

19. The system according to claim 1, wherein said digital pen is adapted for writing in ink on the substrate, so that an ink copy of the writing or drawing of the user is created.

20. The system according to claim 1, wherein the receiver station comprises a memory and is adapted for storing a sequence of digitized positions of handwritten pen strokes in the memory and grouping them as virtual pages corresponding to physical papers being written upon.

21. The system according to claim 20, wherein the receiver station comprises a user operable means for changing the virtual page, such that when these means are operated a new virtual page is started.

22. A system for tracking and processing handwritten pen strokes, the system comprising:
a digital pen to allow a user to write pen strokes on a substrate, said digital pen being adapted for writing in ink on the substrate, so that an ink copy of the pen strokes of the user is created;
a receiver station for use in combination with said digital pen and adapted for tracking said pen strokes, storing digital pen strokes which comprise electronic data representing said tracked pen strokes, and transferring said digital pen strokes to a mobile terminal, said receiver station comprising:
a tracking mechanism adapted for said tracking of pen strokes,
a memory adapted for said storing of said digital pen strokes,
a wireless transceiver adapted for communicating with said mobile terminal over a wireless connection for said transferring of said digital pen strokes to said mobile terminal;
a software application executable on said mobile terminal and comprising software code fragments for receiving said transferred digital pen strokes over said wireless connection and for processing said transferred digital pen strokes.

23. The system according to claim 22, wherein the receiver station is adapted for storing a sequence of digitized positions of handwritten pen strokes in the memory and grouping them as virtual pages corresponding to physical papers being written upon, and wherein the receiver station is adapted for transferring said digital pen strokes grouped as said virtual pages to said mobile terminal.

24. The system according to claim 23, wherein the receiver station comprises a user operable means for changing the virtual page, such that when these means are operated a new virtual page is started.

25. The system according to claim 22, wherein said tracking mechanism is an ultrasound pen tracking mechanism.

26. The system according to claim 22, wherein the receiver station is adapted to be clipped onto the substrate.

27. The system according to claim 22, wherein said software application is in a format executable on one of the following mobile terminals: a smartphone, a PDA, a tablet PC.

28. The system according to claim 27, wherein said software application comprises software code fragments for detecting among said digital pen strokes those which represent handwritten characters.

29. The system according to claim 28, wherein said software application comprises software code fragments for performing handwriting recognition to convert the digital pen strokes which represent handwritten characters into digital characters.

30. The system according to claim 22, wherein said software application comprises software code fragments for integrating data generated from said digital pen strokes into an e-mail.
